(19) United States
(12) Patent Application Publication
(10) Pub. No.: US 2015/0014495 A1
(43) Pub. Date: Jan. 15, 2015

(54) LID HOLDER SYSTEM

(71) Applicant: William J. Bausman, Mound, MN (US)

(72) Inventor: William J. Bausman, Mound, MN (US)

(21) Appl. No.: 14/324,653

(22) Filed: Jul. 7, 2014

Related U.S. Application Data
(60) Provisional application No. 61/846,493, filed on Jul. 15, 2013.

(51) Int. Cl. A47J 47/16

(52) U.S. Cl. CPC A47J 47/16
USPC 248/176.2

(57) ABSTRACT

A system for holding lids is provided. The system illustratively includes a base that comprises a utensil rest. The system also includes a stand connected to the base such that the stand is perpendicular to the base at a connection point and further wherein an axis is also perpendicular to the stand. Further, the system includes a plurality of lid engagement mechanisms connected to the stand.

### CROSS-REFERENCE TO RELATED APPLICATION

The present application claims the priority of provisional application Ser. No. 61/846,493, filed on Jul. 15, 2013, the content of which is hereby incorporated by reference in its entirety.

### BACKGROUND

A common problem in the cooking industry and for cooks of all types is the need to remove lids from pots and pans during the cooking process. However, as pot and pan lids are in contact with the contents of the pots and pans, setting them on the counter or stove top in either a face up or face down position can cause food dripping or condensation, presenting a hot, messy, and potentially dangerous situation.

There exists a need for a lid holding solution that provides a place for the lids of pots and pans to be conveniently placed during the cooking process.

### SUMMARY

A system for holding lids is provided. The system illustratively includes a base that comprises a utensil rest. The system also includes a stand connected to the base such that the stand is perpendicular to the base at a connection point and further wherein an axis is also perpendicular to the stand. Further, the system includes a plurality of lid engagement mechanisms connected to the stand.

These and various other features and advantages that characterize the claimed embodiments will become apparent upon reading the following detailed description and upon reviewing the associated drawings.

### BRIEF DESCRIPTION OF THE DRAWINGS

FIGS. 1A and 1B illustrate a lid holding system in accordance with one embodiment.

FIG. 2A illustrates a front view of a lid holder system in accordance with one embodiment.

FIG. 2B illustrates a diagonal view of a lid holder system in accordance with one embodiment.

FIG. 2C represents a substantially side view of a lid holder system in accordance with one embodiment.

FIG. 2D represents a top down view of a lid holder system in accordance with one embodiment.

FIG. 3 represents an exploded view of a lid holder system in accordance with one embodiment.

FIGS. 4A and 4B illustrate an alternate embodiment of a lid holder system.

FIGS. 5A, 5B, 5C and 5D illustrate alternative base configurations of a lid holder system in accordance with an embodiment.

### DETAILED DESCRIPTION OF ILLUSTRATIVE EMBODIMENTS

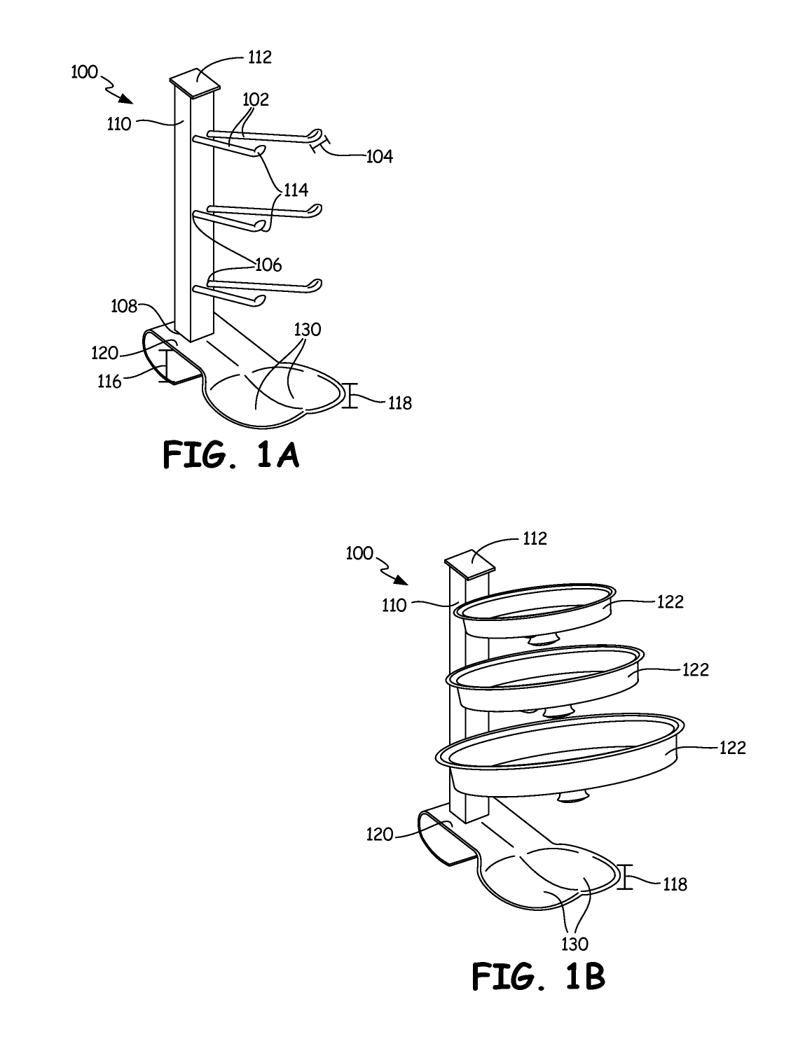

A common problem presenting those working in a kitchen on a stove or with an oven is where to put hot pan and pot covers during the cooking process. A solution to that problem, as shown in one embodiment of the present invention illustrated in FIG. 1, is a lid holder system 100. Lid holder system 100 comprises a stand 110 connected to a base 120, wherein the base 120 further comprises a utensil rest 130. In an alternative embodiment, the base 120 and the utensil rest 130 are two separate portions and are not necessarily formed of a single piece, for example the utensil rest 130 may be removeable for cleaning purposes.

The lid holder system 100 further includes a plurality of holders 102. These holders 102 may, in one embodiment, each further comprise a holder hook 104. The holder 102 is connected to the stand 110 at a holder connection point 106. The stand 110 is connected to the base 120 at a base connection point 108. In one embodiment, the lid holder system 100 also includes a top 112 as shown in FIG. 1. In one embodiment, the holder hook 104 also includes a holder hook cap 114. In one embodiment, the holder hook cap 114 is comprised of a different material than the holder 102. For example, the holder hook may be comprised of rubber or another semi-sticky substance better equipped to grip pan or pot holders or designed specifically to engage with a hot, wet surface. The holder hook cap 114 may be made of the same or different material as the holder 102 and the holder hook 104.

As shown in FIG. 1A, the base 120 is elevated from a surface on which the base 120 sits by a base height 116. This base height 116 may or may not be the same as a utensil rest depth 118. However, in another embodiment, the base 120 may comprise a solid portion that rests on a counter surface and wherein the utensil rest depth 118 comprises a removed section of the base 120. As shown in FIG. 1A, in one embodiment, a lid holder system 100 may include a plurality of utensil rests 130. However, in an alternative embodiment the lid holder system 100 only includes a single utensil rest 130. A utensil that might use the utensil rest 130 could, for example, be a spoon or a fork or a whisk or any other utensil used in a kitchen cooking experience that may be dirty or messy or undesirable to put directly on a counter or stovetop.

As shown in FIG. 1B, the lid holder system 100 holds a plurality of pans 122. The system 100, as shown in FIGS. 1A and 1B, comprises six holders 102 that are configured to hold three pans 122. However, in an alternative embodiment, the lid holder system 100 could include additional holders 102 such that three or four holders 102 are comprised to engage with a single pan 122. Additionally, the stand 110 could be configured such that it can engage with additional holders 102 such that four, five, or any number of pans 122 could be held by the lid holder system. Additionally, as shown in FIGS. 1A and 1B, when the pans 122 are held by the lid holder system, they are held at an angle that is greater than 0° from the horizontal. However, in an alternative embodiment, the pans 122 could be held by the lid holder system 100 such that they are substantially parallel with a counter top or other area upon which the lid holder system 100 is placed. Additionally, in another embodiment, fewer holders 102 are available, such that the stand 120 is available to serve another purpose, for example to hold a roll of paper towels.

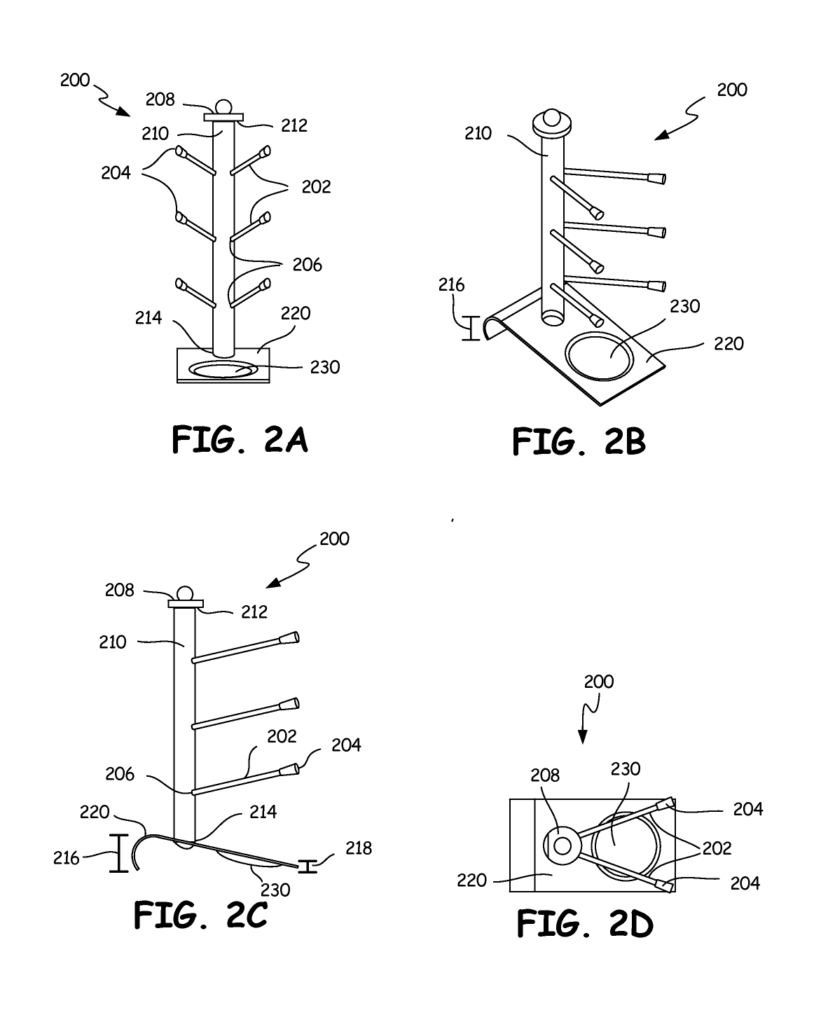

FIG. 2 shows another embodiment of a lid holder system 200 that comprises a stand 210 connected to a base 220 that includes a utensil rest 230. As shown in FIG. 2A, a plurality of holders 202 are connected to the stand 210 such that two holders 202 are configured to engage a single pot or pan holder between the two holders 202. As shown in FIG. 2, the holders 202 comprise straight rods with holder caps 204. The holders 202 engage with the stand 210 at holder connection points 206 and a top 208 engages with the stand 210 at a top connection point 212. Further, the base 220 engages with the stand 210 at a base connection point 214.

The connection points, specifically, the holder connection point 206, the base connection point 214, and the top connection point 212, may or may not all comprise the same connection mechanism. For example, in one embodiment, the stand 210, base 220 and top 208 may be welded together such that they are not easily dismantled by a user of the system. However, in an alternate embodiment, the connection mechanisms may comprise screws, nuts and bolts or other connection mechanisms such that the stand can be easily dismantled and stored according to a preference of the user. Additionally, the holder connection points 206 may be as simple as a user placing the holder into the holder connection point without any further attachment means allowing a user to easily dismantle the lid holder system 200 as necessary. Alternatively, the holder connection point 206 could comprise a system wherein the holder 202 engages with a stand 210 such that each of the holders 202 screws into the stand 210. As shown in FIGS. 2A-2D, the base 220 of the lid holder system 200 has a base height 216 raising the structure from a counter or other position where the lid holder system 200 is placed, and the utensil rest 230 has a utensil rest depth of 217. As shown in FIG. 2, in an alternative embodiment, the utensil rest 230 is removable such that a user can take out the utensil rest 230 for easy cleaning of the lid holder system 100.

FIG. 2C illustrates that the holders 202 are connected to the stand 210 such that they are angled above a horizontal axis defined as perpendicular to the stand 210 at the holder connection point 206, and thus would hold pans at an angle above the same horizontal axis. In this embodiment, the holder hook 104, shown in the embodiment described in FIG. 1, is not necessary to maintain the angle above the horizontal axis.

FIG. 2D shows a top down view of the lid holder system wherein it is shown that the holders 202 are angle away from each other at an angle less than 90° such that they can easily accommodate pans with pan handles or pan tops. However, in another embodiment, the holders 202 could be angled at exactly 90° or greater than 90° from each other.

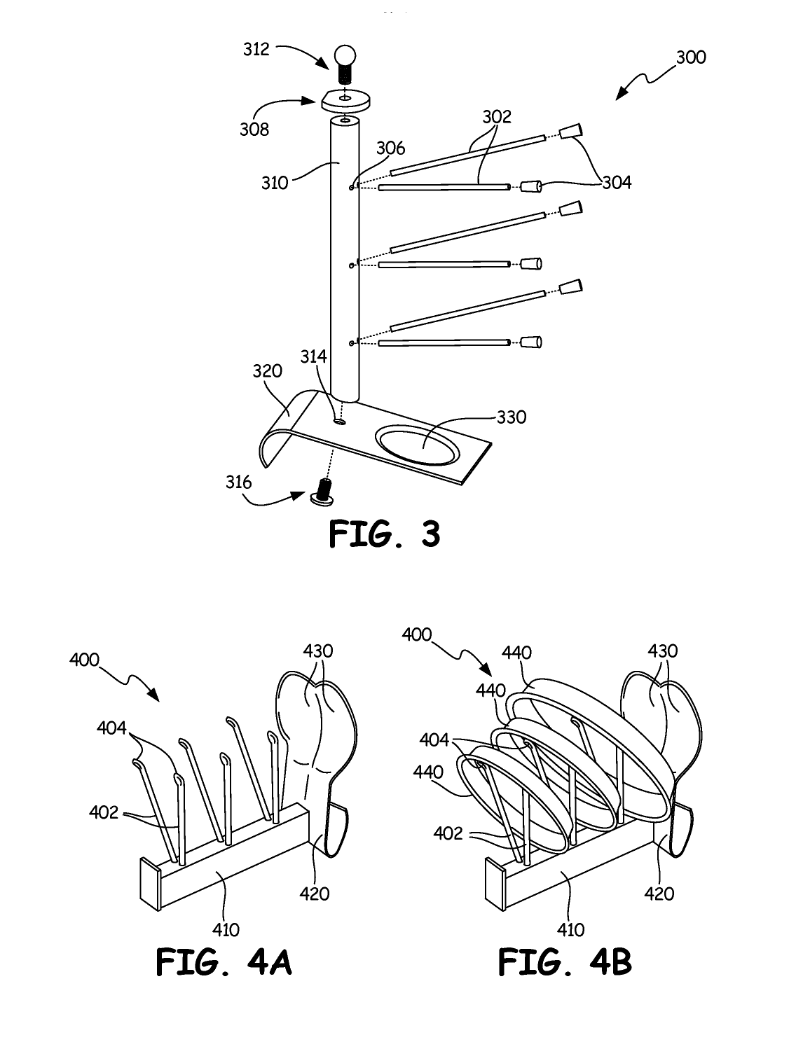

FIG. 3 shows an exploded view of a lid holder system 300 that comprises a stand 310, a base 320, and a utensil rest 330. As shown in FIG. 3, the base 330 may be comprised of a single piece or multiple pieces connected or welded together. In one embodiment, these two pieces are slidably removable for ease of storage. The lid holder system 300 also comprises a plurality of holders 302 that each engage with a holder cap 304. In an alternative embodiment, the holders 302 do not engage with a holder cap 304 and engage directly with a pot or pan holder. The holders 302 engage with the stand 310 at a holder connection point 306.

As shown in FIG. 3, the holder connection point 306 provides a means to permanently fix the holders 302 to the stand 310, for example, by welding. However, in an alternative embodiment, the holders 302 could screw into the stand 310 or otherwise connect to the stand 310 so that they are removable by a user for ease of storage. The lid holder system 310 also comprises a top 308 that is connected to the stand 310 by a top connection mechanism 312. As shown in FIG. 3, the top connection mechanism 312 is a screw with a knob at the top for easy connecting of the top 308 to the stand 310. However, in another embodiment, the top 308 could be simply attached to the stand 310 with a nut and bolt system, or could be welded to the stand 310 as a permanent fixture. The stand 310 and the base 320 connect at a base connection point 314 and are connected by base connection mechanism 316. Base connection mechanism 316 (as shown in FIG. 3) is a screw that screws from the bottom of the base 320 up into the stand 310. However, in an alternative embodiment, the base connection mechanism 316 could comprise welding the stand to the base or using a nut and bolt structure to connect the base to the stand or any other appropriate mechanism for connecting two portions of a lid holder system 300.

FIG. 4 shows a lid holder system 400 in an alternate configuration, wherein the lid holder system 100 has been rotated from the configuration shown in FIG. 1, such that the base 420 is substantially perpendicular to the counter and the stand 410 is substantially parallel to a counter or other place where lid holder system 400 is placed. In this way, pots and pans 440 (as shown in FIG. 4B) are positioned such that they are angled with respect to the counter, stovetop or other place where the lid holder system 400 is placed. In this configuration, the lid holder system 400 comprises a stand 410, a base 420, and a utensil rest 430. Holders 402 are connected to the stand 410 and comprise holder caps 440 at the end of an angled portion of the holders 402. In the embodiment shown in FIGS. 4A and 4B, the lid holder system 400 is comprised of metal (preferably, in one embodiment, steel or aluminum). However, the lid holder system could be comprised of a plastic material in another embodiment, or further could be comprised of wood or bamboo or another biodegradable material in a further embodiment.

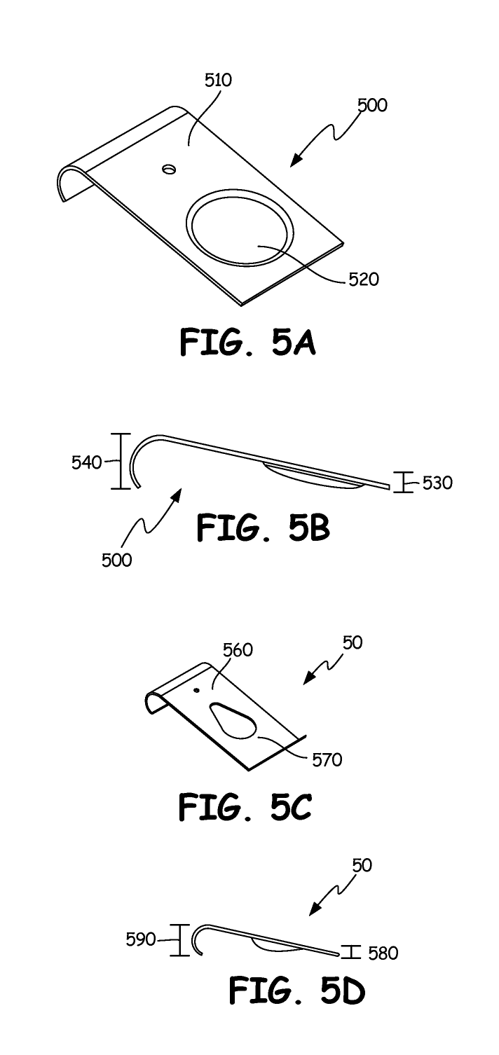

FIGS. 5A-5D show a variety of lid holder base 500 constructs in accordance with another embodiment of the invention. Lid holder base construct 500 comprises a base 510 and a circular holder rest 520 (which has a circular holder rest depth 530). The base 510 has a base height of 540. As shown in FIGS. 5A and 5B, the base height 540 is substantially greater than the circular holder rest depth 530. However, in an alternative embodiment, the circular holder rest depth 530 could be configured such that it engages with the counter, stovetop or other surface upon which the lid holder base construct 500 engages.

FIGS. 5C and 5D illustrate a lid holder base construct 550 in accordance with another embodiment. In this embodiment, the lid holder base construct 550 comprises a base 560 with an oblong holder rest 570 wherein the oblong holder rest 570 comprises a substantially raindrop-shaped rest with an oblong holder rest depth of 580. As shown in FIG. 5D, the oblong holder rest depth 580 has a bottom that is substantially parallel to the counter, stovetop or other area which the lid holder base construct 550 engages and wherein the base 560 has a base height 590. While FIGS. 5A-5D show only a circular and an oblong holder rest shape, any other appropriate shape would work for the lid holder base construct. However, it is noted that shapes with corners (such as squares or rectangles) would not be preferred as those corners would be difficult for a user to clean. Further, it is also noted that, in some embodiments, the utensil rest has a sloped depth such that there are no difficult edges to clean within the utensil rest.

Although the present invention has been described with reference to preferred embodiments, workers skilled in the art will recognize that changes may be made in form and detail without departing from the spirit and scope of the invention.

What is claimed is:

1. A system for holding lids, the system comprising:
a base that comprises a utensil rest;
a stand connected to the base such that the stand is perpendicular to the base at a connection point and further wherein an axis is also perpendicular to the stand; and
a plurality of lid engagement mechanisms connected to the stand, wherein each of the lid engagement mechanisms is configured to suspend a lid such that it is raised above the axis.

2. The system of claim 1, wherein the utensil rest comprises a recessed portion of the base.

3. The system of claim 2, wherein the recessed portion further comprise a plurality of recesses for utensils.

4. The system of claim 1, wherein the connection between the stand and the base comprises a welded connection.

5. The system of claim 1, wherein the connection between the stand and the base comprises a screw.

6. The system of claim 1, wherein the plurality of lid engagement mechanisms comprise a pair of rods that extend substantially perpendicularly from the stand.

7. A convertible lid holder system, the system comprising:
a top;
a base substantially parallel to the top;
a stand connected to the top on a first end and the base on a second end;
a plurality of lid engagement mechanisms connected at a plurality of positions on the stand; and
wherein, in a first position, the top and the base are positioned such that they are perpendicular to an axis, and wherein, in a second position, the top and the base are positioned such that they are parallel to the axis and wherein, in both the first position and the second position the plurality of lid engagement mechanisms are configured to hold a series of lids.

8. The system of claim 7, wherein the base further comprises a utensil rest, and wherein the utensil rest comprises a recessed portion.

9. The system of claim 8, wherein the utensil rest is substantially circular in shape.

10. The system of claim 8, wherein the utensil rest is substantially ovular in shape.

11. The system of claim 8, wherein the recessed portion is a first recessed portion and the utensil rest further comprises a second recessed portion.

12. The system of claim 7, wherein each of the plurality of lid engagement mechanisms comprises a pair of pronged attachments configured to support a lid.

13. The system of claim 12, wherein the pair of pronged attachments further comprises a pair of prong covers attached to the pronged attachments, and wherein the prong covers are configured to increase engagement with a lid.

14. A collapsible lid holder system, the system comprising:
a stand;
a base removeably connected to a first end of the stand;
a plurality of lid engagement mechanisms, wherein each of the plurality of lid engagement mechanisms is removeably connected to the stand along a side of the stand; and
a utensil holder.

15. The system of claim 14, and further comprising a top connected to a second end of the stand.

16. The system of claim 14, wherein the utensil holder comprises a recessed portion within the base.

17. The system of claim 14, wherein the utensil holder comprises a series of recessed portion within the base.

18. The system of claim 14, wherein each of the plurality of lid engagement mechanisms comprises a pair of rods connected to the stand such that they are substantially perpendicular to the stand.

19. The system of claim 18, and further wherein each of the plurality of lid engagement mechanisms comprises a pair of rod covers, and wherein the rod covers are configured to grip a lid.

20. The system of claim 18, wherein each of the rods are removeably connected to the stand.
